(19) United States
(12) Patent Application Publication
(10) Pub. No.: US 2012/0084530 A1
(43) Pub. Date: Apr. 5, 2012

(54) Data Control Method, Data Controller, and Computer Program Product

(76) Inventor: Hideki Ohkita, Tokyo (JP)

(21) Appl. No.: 13/093,614

(22) Filed: Apr. 25, 2011

(30) Foreign Application Priority Data
Sep. 30, 2010 (JP) 2010-222483

(51) Int. Cl. G06F 12/02

(52) U.S. Cl. 711/166; 711/E12.002

(57) ABSTRACT

According to one embodiment, a computer program product includes a non-transitory computer-readable storage medium having computer readable program codes embodied in the medium that are executed on a computer. The computer comprises a storage module that stores a plurality of contents. The use order in which the contents are used is determined. The codes, when executed on the computer, cause the computer to perform: transmitting the contents to an external device to store the contents therein; first determining whether each of the contents stored in the storage module satisfies use condition determined according to the use order; deleting content that does not satisfy the use condition from the storage module; second determining whether content, which is stored in the external device and is not stored in the storage module, satisfies the use condition; and receiving the content from the external device if the content satisfies the use condition.

### CROSS-REFERENCE TO RELATED APPLICATIONS

This application is based upon and claims the benefit of priority from Japanese Patent Application No. 2010-222483, filed Sep. 30, 2010, the entire contents of which are incorporated herein by reference.

### FIELD

Embodiments described herein relate generally to a data control method, a data controller, and a computer program product.

### BACKGROUND

There have been proposed various mobile devices that the user can carry around. If storing content in such a mobile device, the user can use the content at any time.

In recent years, a technology has been proposed to enable program content available directly from the mobile device by providing the mobile device with the functions of recording and playing back digital terrestrial broadcasting programs. However, since the data amount of program content and the like tends to increase, only a limited number of program contents can be stored in the mobile device that has a storage capacity giving priority to portability.

In view of this, a technology has been proposed in which, if the mobile device does not have enough storage capacity to record program content, it instructs another device to store the program content. This prevents a failure in the recording of program content due to the reduced storage capacity.

With the conventional technology, the other device needs the function of receiving digital terrestrial broadcasting, resulting in higher costs.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a mobile device and a personal computer (PC) according to a first embodiment;

FIG. 2 is an exemplary schematic diagram for explaining how program content is used between the mobile device and the PC in the first embodiment;

FIG. 3 is an exemplary block diagram of the mobile device in the first embodiment;

FIG. 4 is an exemplary schematic diagram of a structure of a table stored in a history storage module in the first embodiment;

FIG. 5 is an exemplary schematic diagram for explaining backup control performed by the mobile device in the first embodiment;

FIG. 6 is an exemplary schematic diagram for explaining restore control performed by the mobile device in the first embodiment;

FIG. 7 is an exemplary block diagram of the PC in the first embodiment;

FIG. 8 is an exemplary schematic diagram for explaining the flow of program content between the mobile device and the PC in the first embodiment;

FIG. 9 is an exemplary flowchart of the operation of the mobile device while the user is out in the first embodiment;

FIG. 10 is an exemplary flowchart of the operation of the mobile device after communication is established with the PC in the first embodiment;

FIG. 11 is an exemplary block diagram of a mobile device according to a second embodiment;

FIG. 12 is an exemplary block diagram of a PC in the second embodiment; and

FIG. 13 is an exemplary flowchart of the operation of the PC after communication is established with the mobile device in the second embodiment.

### DETAILED DESCRIPTION

In general, according to one embodiment, a computer program product comprises a non-transitory computer-readable storage medium having computer readable program codes embodied in the medium that are executed on a computer. The computer comprises a storage module configured to store a plurality of contents. The use order in which the contents are used is determined. The codes, when executed on the computer, cause the computer to perform: transmitting the contents to an external device to store the contents in the external device; first determining whether each of the contents stored in the storage module satisfies use condition determined according to the use order; deleting content that does not satisfy the use condition from the storage module; second determining whether content, which is stored in the external device and is not stored in the storage module, satisfies the use condition; and receiving the content from the external device if the content satisfies the use condition.

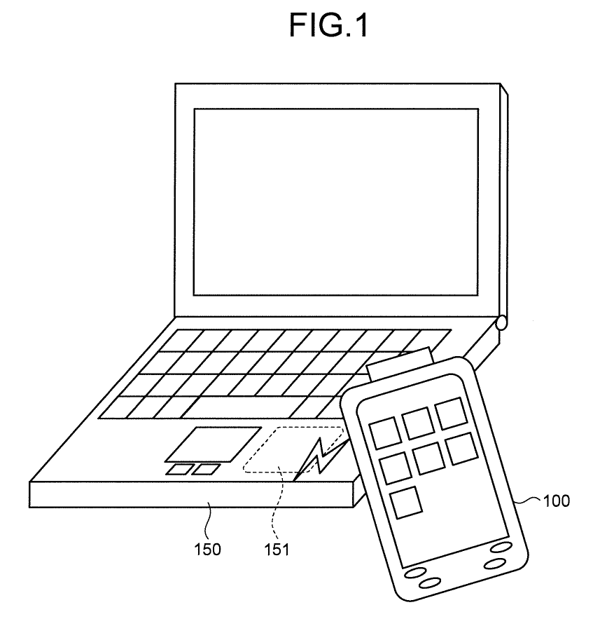

FIG. 1 is a schematic diagram of a mobile device 100 and a personal computer (PC) 150 according to a first embodiment. As illustrated in FIG. 1, the mobile device 100 and the PC 150 can exchange data when they are brought close to each other.

The mobile device 100 and the PC 150 of the first embodiment use TransferJet as an example of a close-proximity wireless transfer technology. The PC 150 has a module 151 embedded therein to communicate via TransferJet. With this technology, by simply holding the mobile device 100 over the PC 150, connection is automatically established between them without direct contact, and they can start high-speed communication. In the first embodiment, while a technology is used in which communication is automatically established when devices are brought close to each other and communication starts, this is by way of example only. For example, other communication technologies such as wireless communication technologies may be used.

In the first embodiment, by using the above close-proximity wireless transfer technology, if the user holds the mobile device 100 over the PC 150 when he/she comes back home or the like, video data is exchanged therebetween.

The mobile device 100 comprises a built-in module to perform close-proximity communication, and is used to view program content.

The program content may be video data received via digital terrestrial broadcasting or downloaded from the Internet. The program content contains metadata including various types of information about the program. While an example is described herein in which program content is managed, other content such as music content, image content, and the like may be managed.

The use order in which program contents are used is determined in advance in the metadata. The use order may be determined, for example, and without limitation, based on episodes of a television series or the number of special programs. The use order may also be the time-series order of programs (news show, sports program, etc.) or the order in which the program contents are recommended.

The mobile device 100 may be any device that the user can carry around. Examples of the mobile device 100 include a third-generation (3G) wireless communication module, a mobile device comprising a module capable of communication using a mobile telephone line, a mobile netbook, a mobile phone, and the like.

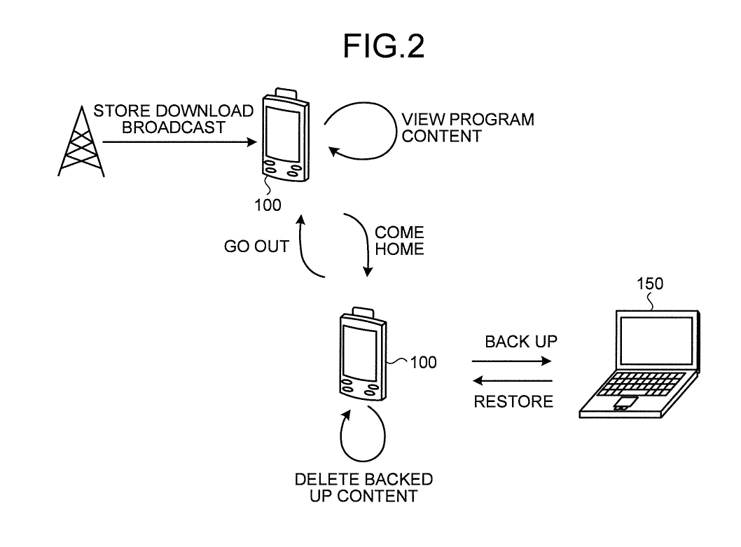

In the following, a description will be given of how program content is used between the mobile device 100 and the PC 150 in the first embodiment. FIG. 2 is a schematic diagram for explaining how program content is used between the mobile device 100 and the PC 150 in the first embodiment.

As illustrated in FIG. 2, the mobile device 100 stores download broadcast program content at an outside location or the like. The user views the program content with the mobile device 100 while away from home or the like. Then, when the user comes back home, after communication is established between the mobile device 100 and the PC 150, the mobile device 100 backs up the program content to the PC 150. The mobile device 100 also deletes program content that the user is not likely to view soon therefrom. On the other hand, the mobile device 100 restores program content that the user is likely to view soon from the PC 150. The program content that the user is likely to view soon is assumed to be a consequence of the program content viewed by the user at an outside location (the next or the following program content in the use order).

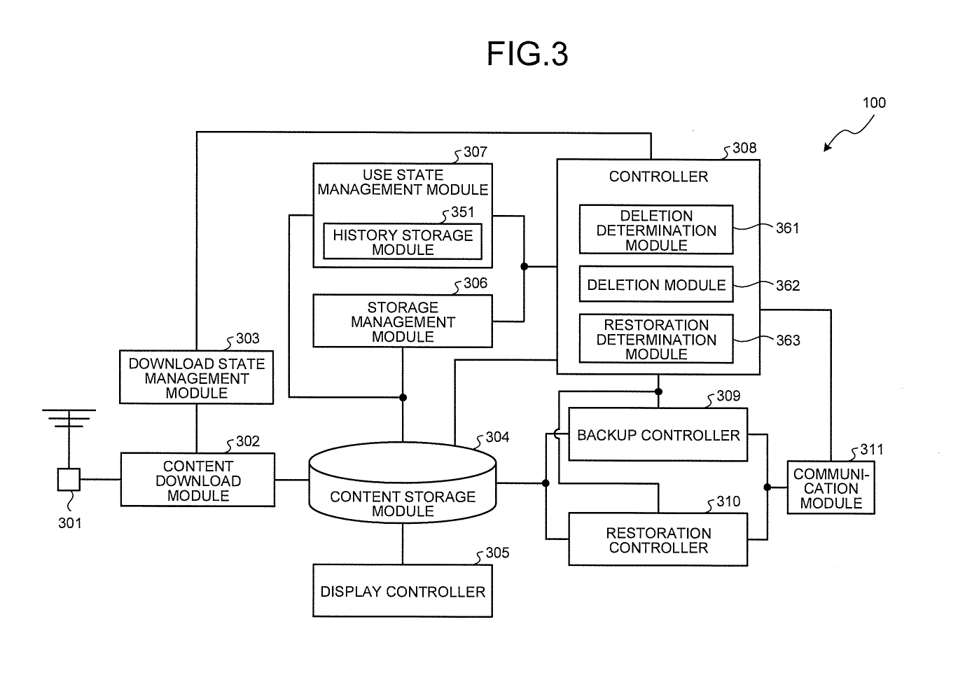

Next, the mobile device 100 will be described. FIG. 3 is a block diagram of the mobile device 100. As illustrated in FIG. 3, the mobile device 100 comprises an antenna 301, a content download module 302, a download state management module 303, a content storage module 304, a display controller 305, a storage management module 306, a use state management module 307, a controller 308, a backup controller 309, a restoration controller 310, and a communication module 311.

The antenna 301 receives download broadcast. The download broadcast may be, for example, one segment broadcasting, broadcasting based on the integrated services digital broadcasting for terrestrial mobile multi-media broadcasting (ISDB-Tmm) standard for multimedia broadcasting for mobile terminals, and the like. By using such a communication standard, the antenna 301 can receive not only video data but also a variety of content such as a music file, an electronic book, and the like. It is no object whether content to be received is encrypted.

The communication module 311 establishes connection to the PC 150 as a backup device, and communicates with the PC 150. While the communication module 311 is described herein as a communication functional module that performs communication via TransferJet that is a close-proximity wireless transfer technology using an ultra wide band (UWB), other communication technologies such as universal serial bus (USB), Bluetooth (registered trademark), or the like may be used.

The content download module 302 downloads program content from download broadcast received by the antenna 301. At this time, the content download module 302 obtains program contents in the use order in the download broadcast. The content download module 302 stores the downloaded program content in the content storage module 304.

The download state management module 303 manages downloading by the content download module 302. More specifically, the download state management module 303 of the first embodiment associates a series title, an episode number, and a flag indicating whether program content is downloaded with one another to manage the download state of the program content. The download state management module 303 determines whether program content downloaded by the content download module 302 is completely downloaded. If the program content is not completely downloaded, the download state management module 303 notifies the controller 308 of this so that the program content is not to be backed up or deleted.

The content storage module 304 stored program content. The program content to be stored contains the use order such as an episode number by metadata. If the program content is encrypted, only when the content storage module 304 of the mobile device 100 stores the program content, the program content may be viewed. Besides, the metadata need not necessarily be referred to for checking the use order. An episode number or the like contained in the metadata may be managed by a table created additionally or the like.

The storage management module 306 manages the use state (available and unavailable storage space) of the content storage module 304. The storage management module 306 stores a threshold to set the amount of program contents to be stored in the content storage module 304. In the first embodiment, if, for example, program contents of a drama series are stored in the content storage module 304, the threshold is set to three episodes.

The display controller 305 controls display of program content stored in the content storage module 304 on a display module (not illustrated).

The use state management module 307 comprises a history storage module 351, and manages the view state of program content stored in the content storage module 304.

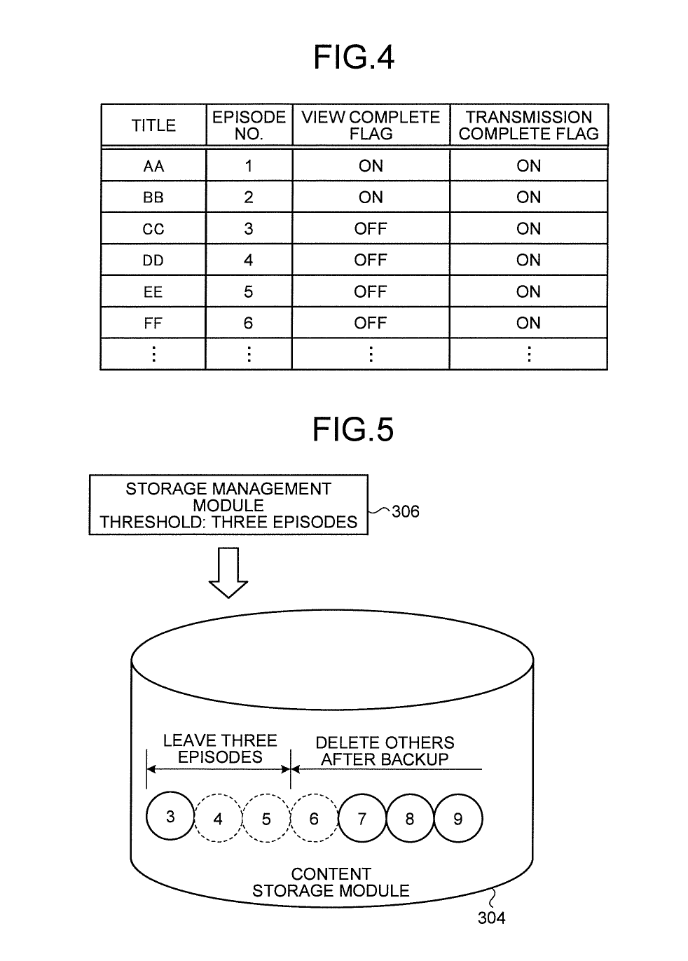

FIG. 4 illustrates an example of a structure of a table stored in the history storage module 351. As illustrated in FIG. 4, the history storage module 351 stores the title of program content, an episode number, a view complete flag, and a transmission complete flag in association with one another. If the program content does not contain a plurality of episodes, for example, broadcast time or recommendation order is set as the use order to the table instead of the episode number. The view complete flag is set to ON with respect to program content for which the display controller 305 completes display control. On the other hand, the view complete flag is set to OFF with respect to program content for which the display controller 305 has not performed display control. The transmission complete flag is set to ON with respect to program content transmitted to the PC 150. On the other hand, the transmission complete flag is set to OFF (not illustrated) with respect to program content yet to be transmitted to the PC 150.

While the history storage module 351 is described herein as managing whether program content has been viewed using the table, it is not so limited. The history storage module 351 may manage the view state of program content using, for example, a pointer or the like.

The controller 308 comprises a deletion determination module 361, a deletion module 362, and a restoration determination module 363. The controller 308 performs processing on program content stored in the content storage module 304. Besides, the controller 308 controls the communication module 311 to control the exchange of program content.

The deletion determination module 361 determines whether program content stored in the content storage module 304 satisfies use condition representing the possibility that the user uses the program content referring to the history storage module 351. It is assumed herein that, in program contents of a series yet to be viewed, program contents of three episodes in the episode order are determined to be probably used under the use condition. The deletion determination module 361 determines that program contents of three episodes yet to be viewed satisfy the use condition, while it determines that program contents of the following episodes do not satisfy the use condition. Incidentally, program content determined to be deleted by the deletion determination module 361 is set as having been transmitted to the PC 150 in the history storage module 351. That is, the deletion determination module 361 determines to delete only program content that has already been backed up to the PC 150. While, in the first embodiment, program contents of three episodes yet to be viewed in the use order is set to the use condition, the use condition is not so limited, and may be determined in any manner according to the use order.

Although three episodes are set as the threshold to determine whether to delete program content, the threshold may be determined based on the capacity of the content storage module 304. For example, if the maximum capacity of the content storage module 304 is 30 gigabytes (GB), when program contents occupy the capacity exceeding 15 GB, the deletion determination module 361 may determine that episodes corresponding to the exceeding capacity satisfy the condition to delete program content.

The deletion module 362 deletes program content that the deletion determination module 361 determines does not satisfy the use condition from the content storage module 304.

Besides, when program content stored in the content storage module 304 is used (viewed), if the program content has already been backed up, the deletion module 362 deletes the program content.

The restoration determination module 363 determines whether program content stored in the PC 150 satisfies the use condition. More specifically, the restoration determination module 363 determines whether, in program contents yet to be viewed, program contents of up to three episodes in the episode order satisfies the use condition.

In the first embodiment, when the communication module 311 establishes communication, the controller 308 instructs the backup controller 309 and the PC 150 to back up program content stored in the content storage module 304 based on information obtained from the storage management module 306 and the use state management module 307. After that, the deletion module 362 deletes program content that is less likely to be viewed soon based on the determination result of the deletion determination module 361.

Further, the controller 308 instructs the restoration controller 310 and the PC 150 to restore part of program contents backed up on the PC 150 based on information obtained from the use state management module 307.

The backup controller 309 refers to the history storage module 351 and transmits a plurality of program contents yet to be backed up to the PC 150 that stores content to back up the program contents. After backing up the program contents, the backup controller 309 updates the transmission complete flag of the history storage module 351 to ON with respect to each of the program contents. In this manner, all program contents stored in the content storage module 304 of the mobile device 100 are stored in the PC 150.

FIG. 5 is a schematic diagram for explaining backup control performed by the mobile device 100 of the first embodiment. As illustrated in FIG. 5, for example, the storage management module 306 stores a threshold determined as three episodes. In the example of FIG. 5, the third, seventh, eighth, and ninth episodes of a series are stored in the content storage module 304. The fourth to sixth episodes have already been backed up to the PC 150. The seventh to ninth episodes have been received at an outside location and not yet been backed up. The user has already viewed the first and second episodes so far, and the third episode is stored in the content storage module 304.

In this case, the backup controller 309 backs up the seventh to ninth episodes stored in the content storage module 304. After that, the deletion module 362 leaves program contents of three episodes from the third episode as those that are likely to be viewed soon, and deletes the following program contents.

The restoration controller 310 performs restore control with the PC 150 with respect to program contents that the restoration determination module 363 determines satisfies the use condition, i.e., program contents of up to three episodes yet to be viewed, and receives the program contents.

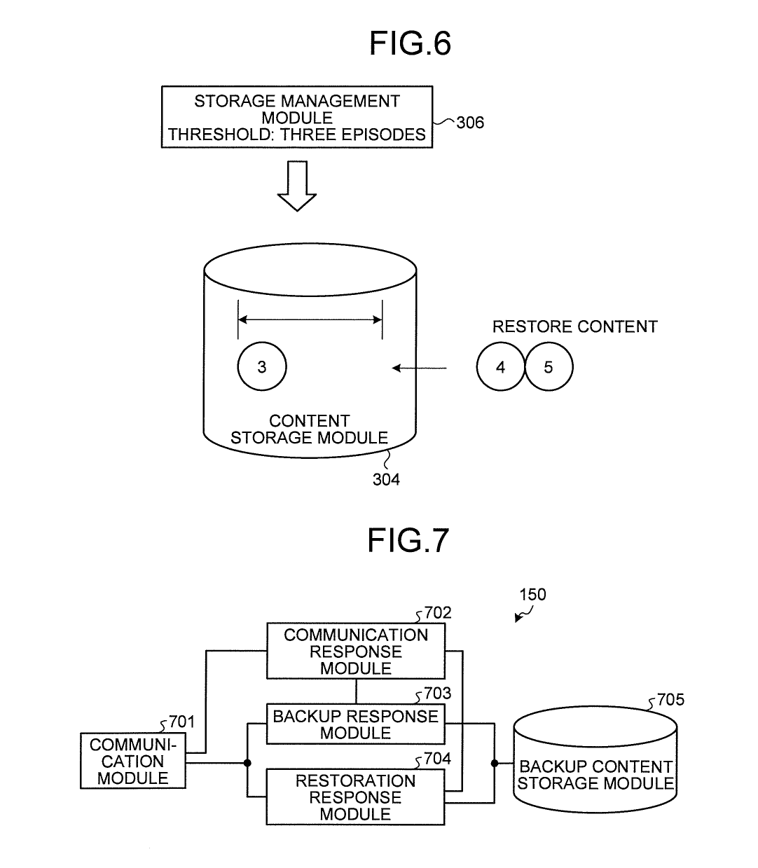

FIG. 6 is a schematic diagram for explaining the restore control performed by the mobile device 100 of the first embodiment. In the restore control also, three episodes are set as a threshold. As illustrated in FIG. 6, if program content of only the third episode is stored in the content storage module 304 after backup, the restoration determination module 363 determines the fourth and fifth episodes to be restored among three episodes (threshold) from the third episode (the third to fifth episodes) that are likely to be viewed. According to the determination result, the restoration controller 310 restores the fourth and fifth episodes from the PC 150 to the content storage module 304.

Next, the PC 150 will be described. FIG. 7 is a block diagram of the PC 150. As illustrated in FIG. 7, the PC 150 comprises a communication module 701, a communication response module 702, a backup response module 703, a restoration response module 704, and a backup content storage module 705.

The communication module 701 establishes connection to the mobile device 100 and communicates with the mobile device 100.

The communication response module 702 controls communication according to an instruction from the mobile device 100 after the communication module 701 establishes communication with the mobile device 100. The communication response module 702 controls the backup response module 703 and the restoration response module 704.

The backup content storage module 705 stores program content backed up from the mobile device 100.

The backup response module 703 stores program content received from the mobile device 100 in the backup content storage module 705 under the control of the communication response module 702.

The restoration response module 704 reads program content from the backup content storage module 705 in response to a request from the mobile device 100 to send the program content thereto under the control of the communication response module 702. With this restore control by the restoration response module 704, the mobile device 100 obtains the program content.

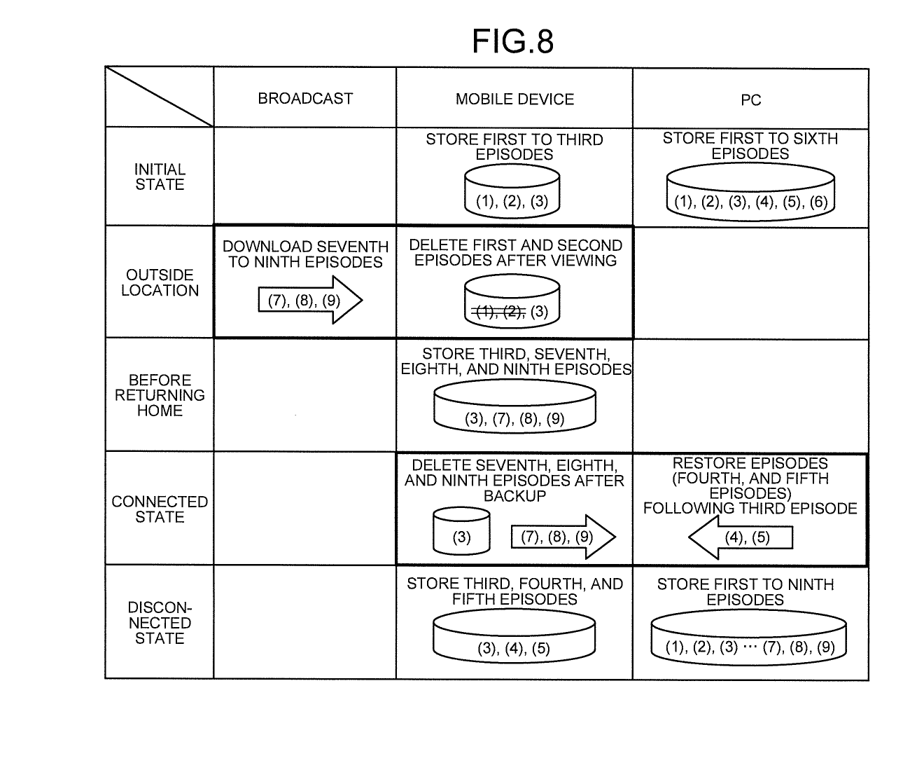

FIG. 8 is a schematic diagram for explaining the flow of program content between the mobile device 100 and the PC 150. FIG. 8 illustrates by way of example program contents of a drama series, the order in which they are viewed is already determined.

In the example of FIG. 8, it is assumed that the mobile device 100 has downloaded and backed up program content several times. Thus, in “initial state”, the mobile device 100 stores program contents of the first to third episodes, while the PC 150 stores program contents of the first to sixth episodes.

At an “outside location”, the user views the first and second episodes on the mobile device 100. With this, the deletion module 362 of the mobile device 100 deletes the first and second episodes from the content storage module 304. Besides, at an outside location, the seventh to ninth episodes are downloaded from download broadcasting.

Accordingly, “before returning home”, the content storage module 304 of the mobile device 100 stores the third episode and the seventh to ninth episodes.

After the user comes back home, the mobile device 100 is connected to the PC 150. In this “connected state”, the backup controller 309 backs up the seventh to ninth episodes, which have not yet been backed up, to the PC 150. After the backup, the deletion determination module 361 determines that the seventh to ninth episodes do not satisfies the use condition, i.e., program contents of three episodes yet to be viewed (the third to fifth episodes). Accordingly, the deletion module 362 deletes the seventh to ninth episodes as being less likely to be viewed soon by the user. Thus, the available capacity of the content storage module 304 is ensured.

Subsequent to ensuring the available capacity, the restoration determination module 363 determines that the fourth and fifth episodes stored in the backup content storage module 705 satisfies the use condition. According to the determination result, the restoration controller 310 performs restore control with the PC 150 to store the fourth and fifth episodes in the content storage module 304.

With this, in “disconnected state”, the content storage module 304 of the mobile device 100 stores the third, fourth, and fifth episodes. Meanwhile, the backup content storage module 705 of the PC 150 stores all download broadcasted episodes, i.e., the first to ninth episodes. In this manner, in the mobile device 100 of the first embodiment, only the highest order three episodes remain among program contents yet to be viewed, and thereby the available capacity is ensured. While the threshold is described herein as being set to three episodes, it is not limited to three episodes, and may be set to an appropriate value corresponding to the type of content or the capacity of the storage module.

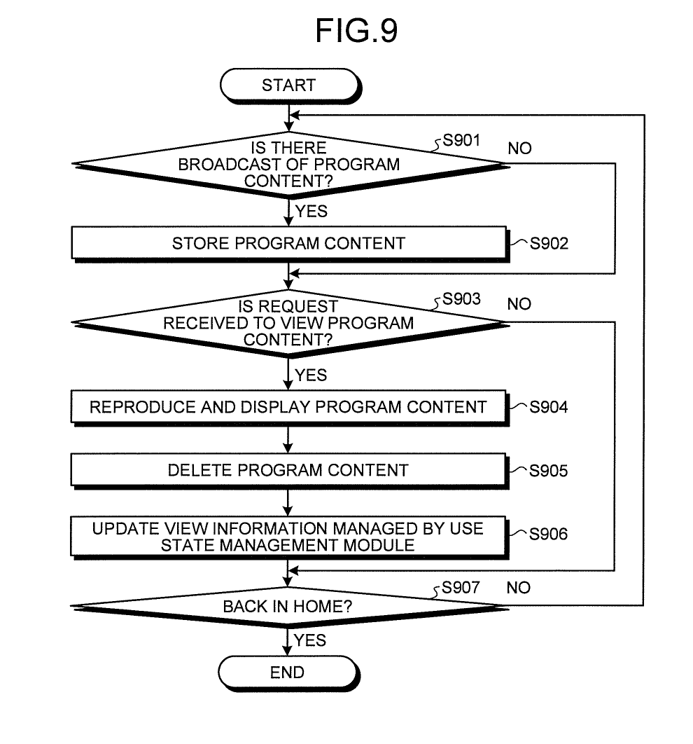

In the following, a description will be given of the operation of the mobile device 100 while the user is out. FIG. 9 is a flowchart of this operation of the mobile device 100.

First, the content download module 302 determines whether there is download broadcast of program content via the antenna 301 (S901). If there is no download broadcast (No at S901), the process moves to S903.

On the other hand, if the content download module 302 determines that there is download broadcast (Yes at S901), the content storage module 304 stores download broadcast program content (S902).

Then, the mobile device 100 determines whether a request is received from the user to view the program content (S903). If such a request is not received (No at S903), the process moves to S907.

On the other hand, if a request is received from the user (Yes at S903), the display controller 305 reproduces and displays the requested program content (S904). After the user views the program content, if the viewed program content has already been backed up to the PC 150, the deletion module 362 deletes the program content (S905).

After that, the use state management module 307 updates the history storage module 351 to indicate that the program content has been viewed (S906).

It is then determined whether the user is back in home and the mobile device 100 is connected to the cradle or the like (S907). If the user is still out (No at S907), the process returns to S901. On the other hand, if the user is back in home (Yes at S907), the process ends.

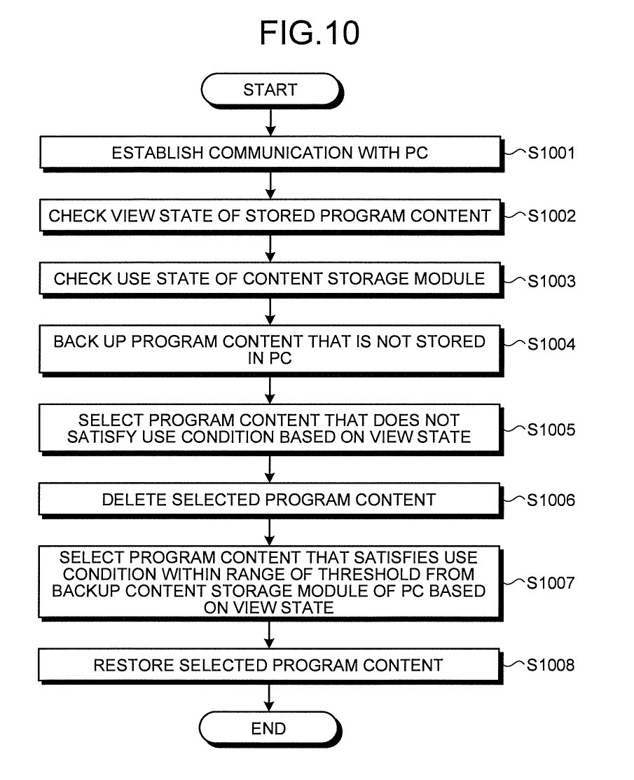

Next, a description will be given of the operation of the mobile device 100 after communication is established with the PC 150. FIG. 10 is a flowchart of this operation of the mobile device 100.

First, the communication module 311 of the mobile device 100 establishes communication with the PC 150 (S1001).

Referring to the history storage module 351, the controller 308 checks the view state of program content stored in the content storage module 304 (S1002). With reference to the history storage module 351, the controller 308 can specify program content yet to be stored in the PC 150.

The controller 308 then refers to the storage management module 306 and checks the use state of the content storage module 304 (S1003). The controller 308 checks whether the content storage module 304 has a space available to restore program content based on the use state.

After that, the backup controller 309 backs up program content that is not stored in the PC 150 (S1004).

Then, the deletion determination module 361 selects program content that does not satisfy the use condition representing the possibility that the user uses (views) the program content soon based on the view state stored in the history storage module 351 (S1005). In the example of FIG. 8, the deletion determination module 361 selects the seventh, eighth, and ninth episodes after three episodes (threshold) from the third episode. The deletion module 362 deletes the selected program content (S1006).

The restoration determination module 363 selects program content that satisfies the use condition representing the possibility that the user uses (views) the program content soon within the range of the threshold from the backup content storage module 705 of the PC 150 based on the view state stored in the history storage module 351 (S1007). The restoration controller 310 performs restore control on the selected program content (S1008).

With the process as described above, it is possible to restore content to be used soon and back up download broadcast program content.

As described above, according to the first embodiment, with the configuration as described above, the mobile device 100 can ensure the available capacity of the content storage module 304 while storing content that is likely to be viewed. Besides, all contents are stored in the PC 150, and thus any content is available in response to a request from the user.

Although an example is described above in which the threshold is set to three episodes in the case of a drama series, the number of episodes to be stored in the content storage module 304 is not limited to three. The threshold to determine whether to delete content may be the available capacity of the content storage module 304 instead of the number of episodes. For example, if the capacity of the content storage module 304 is 30 GB, when program contents occupy the capacity exceeding 15 GB, the controller 308 controls the deletion module 362 to delete program content not to be used soon.

Besides, the content storage module 304 is described above as storing one type of program content, it is not so limited and the content storage module 304 may store a plurality of types of program content. In this case, the threshold may vary depending on the type of content to be stored. For example, the threshold may be set to three episodes to store one type of content, while it may be set to two episodes to store two types of content. The threshold is calculated by dividing the threshold 3 by 2 (=1.5) and rounding up 1.5 to 2. The threshold may be set in advance depending on the number of types of content.

Further, if a plurality of types of content is to be stored, with respect to each type of content, the threshold may vary depending on the possibility that the user views the content. For example, when a plurality of types of content is to be stored in the content storage module 304, the storage management module 306 may set a large threshold with respect to a type of content that the user frequently views. In this case, the storage management module 306 determines whether content is of the type that the user frequently views referring to the history storage module 351. Having determined that it is the type of content that the user frequently views, the storage management module 306 sets a larger threshold for this type of content than other types of content.

With the process as described above, content to be stored in the mobile device 100 can be set according to the convenience of the user.

A second embodiment will be described. While, in the first embodiment, backup and restore controls are described as being performed by the mobile device side, this is by way of example and not limitation. These controls may be performed by the PC side. In the second embodiment, an example will be described in which backup and restore controls are performed by the PC side.

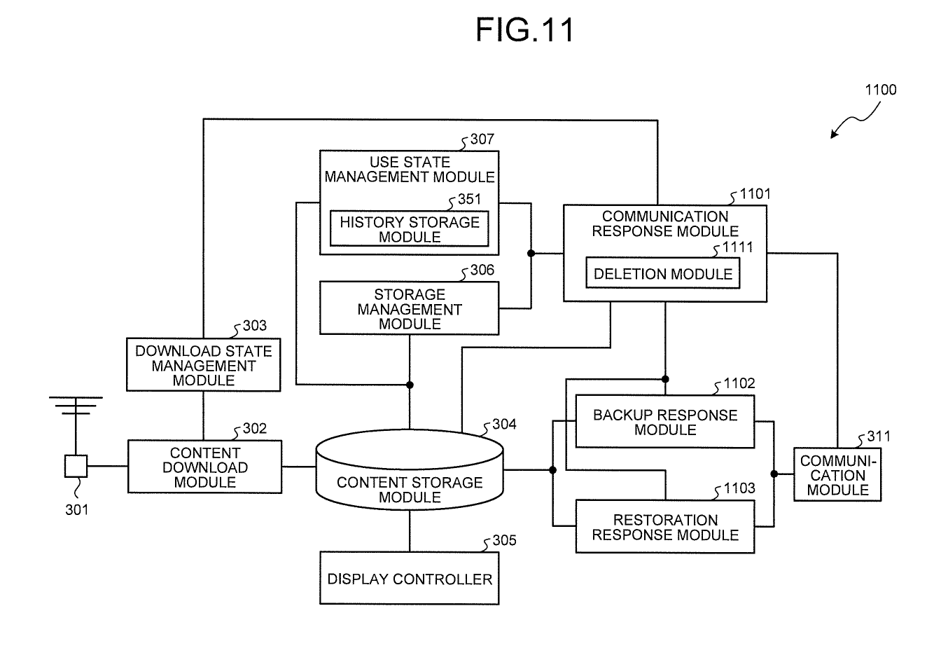

FIG. 11 is a block diagram of a mobile device 1100 according to the second embodiment. The mobile device 1100 of the second embodiment is of basically the same configuration as the mobile device 100 of the first embodiment except the presence of a communication response module 1101, a backup response module 1102, and a restoration response module 1103 instead of the controller 308, the backup controller 309, and the restoration controller 310. Therefore, like elements as described in the first embodiment are designated by like reference numerals, and their description will not be repeated.

The communication response module 1101 controls the backup response module 1102 and the restoration response module 1103 under the control of a PC 1200 as a backup device, which will be described later. Besides, in response to a request from the PC 1200, the communication response module 1101 provides the PC 1200 with information managed by the storage management module 306 and the use state management module 307.

The communication response module 1101 comprises a deletion module 1111 that deletes program content under the control of the PC 1200. The deletion module 1111 also deletes program content that the user has viewed as in the first embodiment.

The backup response module 1102 performs backup response control between the mobile device 1100 and the PC 1200 according to an instruction from the communication response module 1101.

The restoration response module 1103 performs restoration response control between the mobile device 1100 and the PC 1200 according to an instruction from the communication response module 1101.

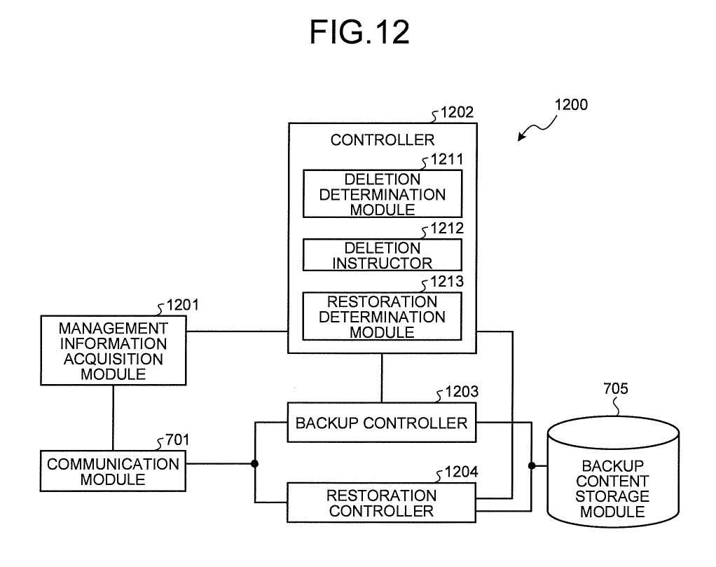

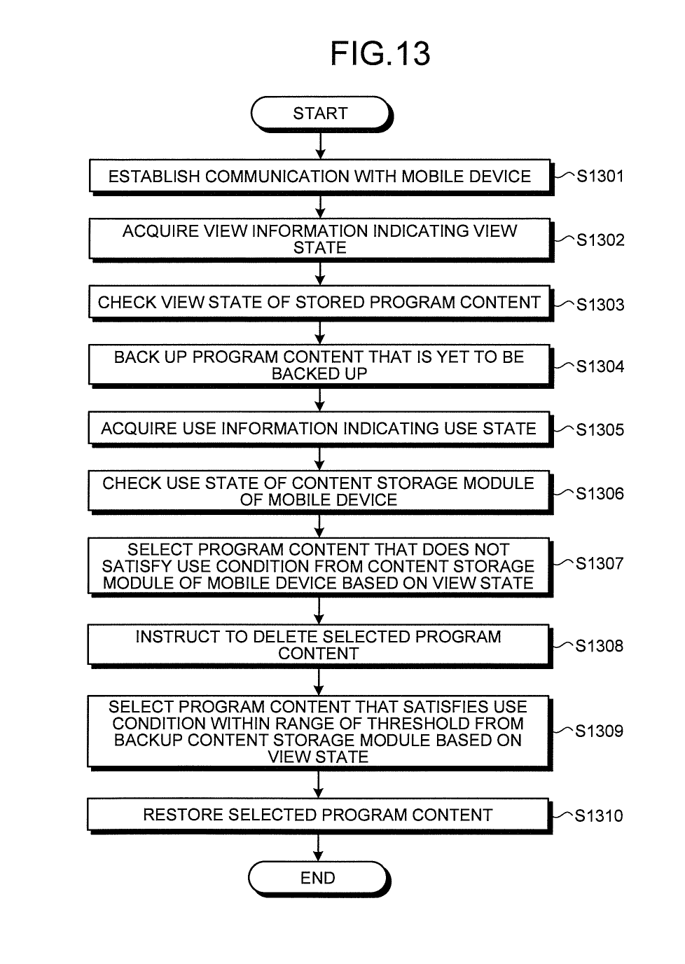

FIG. 12 is a block diagram of the PC 1200 of the second embodiment. The PC 1200 of the second embodiment is different from the PC 150 of the first embodiment in that it further comprises a management information acquisition module 1201. Besides, the PC 1200 comprises a controller 1202, a backup controller 1203, and a restoration controller 1204 instead of the communication response module 702, the backup response module 703, and the restoration response module 704. Like elements as described in the first embodiment are designated by like reference numerals, and their description will not be repeated.

The management information acquisition module 1201 acquires information managed by the storage management module 306 and the use state management module 307 from the mobile device 1100 after communication with the mobile device 1100 is established.

The controller 1202 comprises a deletion determination module 1211, a deletion instructor 1212, and a restoration determination module 1213. The controller 1202 controls program content stored in the content storage module 304 of the mobile device 1100 by controlling the communication module 701 to transmit and receive program content.

In the second embodiment, after the communication module 701 establishes communication with the mobile device 1100, the management information acquisition module 1201 acquires information managed by the storage management module 306 and the use state management module 307. The controller 1202 issues an backup control instruction to the backup controller 1203 and the mobile device 1100 based on the information. With this, program content stored in the content storage module 304 of the mobile device 1100 is bucked up.

The deletion determination module 1211 determines whether program content stored in the content storage module 304 satisfies use condition representing the possibility that the user uses the program content referring to information stored in the history storage module 351 obtained from the mobile device 1100. The deletion determination module 1211 makes the determination in the same manner as previously described in the first embodiment, and the description will not be repeated.

The deletion instructor 1212 instructs the mobile device 1100 to delete program content that the deletion determination module 1211 determines does not satisfy the use condition from the content storage module 304.

The restoration determination module 1213 determines whether program content stored in the PC 1200 satisfies the use condition based on the information managed by the storage management module 306 and the use state management module 307. The restoration determination module 1213 makes the determination in the same manner as previously described in the first embodiment, and the description will not be repeated.

According to an instruction from the controller 1202, the backup controller 1203 receives a plurality of program contents yet to be backed up from the mobile device 1100 based on the information obtained from the history storage module 351, and backs up the program contents.

The restoration controller 1204 performs restore control with the mobile device 1100 with respect to program contents that the restoration determination module 1213 determines satisfies the use condition, i.e., program contents of up to three episodes yet to be viewed, and transmits the program contents.

In the following, a description will be given of the operation of the PC 1200 after communication is established with the mobile device 1100 in the second embodiment. FIG. 10 is a flowchart of this operation of the PC 1200 of the second embodiment.

First, the communication module 701 of the PC 1200 establishes communication with the mobile device 1100 (S1301).

The management information acquisition module 1201 acquires view information indicating view state stored in the history storage module 351 of the mobile device 1100 (S1302). Referring to the view information acquired from the history storage module 351, the controller 1202 checks the view state of program content stored in the content storage module 304 (S1303). With reference to the history storage module 351, the controller 1202 can specify program content yet to be stored in the PC 1200.

After that, the backup controller 1203 backs up program content that is not stored in the PC 1200 (S1304).

The management information acquisition module 1201 then acquires use information indicating use state of the content storage module 304 stored in the storage management module 306 of the mobile device 1100 (S1305). The controller 308 checks the use state of the content storage module 304 referring to the use information acquired from the storage management module 306 (S1306). The controller 308 checks whether the content storage module 304 has a space available to restore program content based on the use state.

Then, the deletion determination module 1211 selects program content that does not satisfy the use condition representing the possibility that the user uses (views) the program content soon from those stored in the content storage module 304 based on the view state (S1307). The deletion instructor 1212 instructs the mobile device 1100 to delete the selected program content (S1308). According to the instruction, the deletion module 1111 of the mobile device 1100 deletes the selected program content.

The restoration determination module 1213 selects program content that satisfies the use condition representing the possibility that the user uses (views) the program content soon within the range of the threshold from the backup content storage module 705 based on the view state (S1309). The restoration controller 1204 performs restore control with the mobile device 1100 via the communication module 701 so that the selected program content is stored in the content storage module 304 of the mobile device 1100 (S1310).

With the process as described above, it is possible to restore content to be used soon and back up download broadcast program content.

As described above, according to the first and the second embodiments, in file casting for multimedia broadcasting for mobile terminals, when a mobile device or the like is connected to a backup device such as a PC, among contents stored in the mobile device, content that is likely to be viewed can be left in the mobile device in consideration of the capacity of the content storage module of the mobile device. Besides, possible overflow in the content storage module can be prevented. Furthermore, more contents can be managed with the content storage module having the same capacity. That is, the content storage module can be used more efficiently.

The mobile device of the above embodiment comprises a controller such as a central processing unit (CPU), a storage device such as a read only memory (ROM) and a random access memory (RAM), an external storage device such as a hard disk drive (HDD) and a compact disc (CD) drive, a display device such as a liquid crystal display (LCD), and an input device such as a keyboard and a mouse. That is, the mobile device has a hardware configuration using an ordinary computer.

A computer program (hereinafter, “data control program”) can be executed on a computer to realize the same function as the mobile device of the above embodiment. The data control program may be provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The data control program may also be stored in a computer connected via a network such as the Internet so that it can be downloaded therefrom via the network. Further, the data control program may be provided or distributed via a network such as the Internet.

Still further, the data control program may be provided as being stored in advance in ROM or the like.

The data control program comprises modules that implement the above constituent elements (the content download module, the download state management module, the use state management module, the storage management module, the display controller, the controller, the backup controller, the restoration controller). As real hardware, the CPU (processor) loads the data control program from the storage medium as described above into the main memory and executes it. With this, the content download module, the download state management module, the use state management module, the storage management module, the display controller, the controller, the backup controller, the restoration controller are implemented on the main memory.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer program product comprising a non-transitory computer-readable storage medium having computer readable program codes embodied in the medium that are executed on a computer, wherein
the computer comprises a storage module configured to store a plurality of contents, a use order in which the contents are used is determined, and
the codes, when executed on the computer, cause the computer to perform:
transmitting the contents to an external device to store the contents in the external device;
first determining whether each of the contents stored in the storage module satisfies use condition determined according to the use order;
first deleting content determined at the first determining not to satisfy the use condition from the storage module;
second determining whether content, which is stored in the external device and is not stored in the storage module, satisfies the use condition; and
receiving the content from the external device if the content is determined at the second determining to satisfy the use condition.

2. The computer program product of claim 1, wherein the codes further causes the computer to perform, if content stored in the storage module is used, second deleting the content.

3. The computer program product of claim 1, wherein the codes further causes the computer to perform:
acquiring the contents according to the use order; and
storing the contents acquired at the acquiring in the storage module.

4. The computer program product of claim 3, wherein the codes further causes the computer to perform:
determining whether the contents are acquired properly at the acquiring; and
preventing, if it is determined at the determining that the contents are not acquired properly, the contents stored in the storage module from being transmitted or deleted.

5. The computer program product of claim 1, wherein the first determining comprises determining that, among the contents stored in the storage module, up to a predetermined number of contents from a first content in the use order satisfy the use condition, and content following the predetermined number of contents does not satisfy the use condition.

6. The computer program product of claim 5, wherein the predetermined number is determined based on a capacity of the storage module.

7. A data control method applied to a mobile device comprising a storage module configured to store a plurality of contents, a use order in which the contents are used is determined, the data control method comprising:
transmitting the contents to an external device to store the contents in the external device;
first determining whether each of the contents stored in the storage module satisfies use condition determined according to the use order;
deleting content determined at the first determining not to satisfy the use condition from the storage module;
second determining whether content, which is stored in the external device and is not stored in the storage module, satisfies the use condition; and
receiving the content from the external device if the content is determined at the second determining to satisfy the use condition.

8. A data control device that is connectable to a mobile device comprising a first storage module configured to store a plurality of contents, a use order in which the contents are used is determined, the data control device comprising:
a second storage module configured to store content;
a storage controller configured to store content stored in the first storage module of the mobile device in the second storage module;
a first determination module configured to determine whether each of the contents stored in the first storage module satisfies use condition determined according to the use order;
an instruction module configured to instruct the mobile device to delete content that the first determination module determines does not satisfy the use condition;
a second determination module configured to determine whether to output the content stored in the second storage module to the first storage module of the mobile device based on the use condition referring to the contents stored in the first storage module; and
an output module configured to output the content stored in the second storage module to the first storage module of the mobile device according to a determination result of the second determination module.
